(19) United States
(12) Patent Application Publication
(10) Pub. No.: US 2013/0170562 A1
(43) Pub. Date: Jul. 4, 2013

(54) DEBLOCKING DECISION FUNCTIONS FOR VIDEO CODING

(71) Applicant: QUALCOMM Incorporated, San Diego, CA (US)

(72) Inventors: Geert Van der Auwera, San Diego, CA (US); Xianglin Wang, San Diego, CA (US); Marta Karczewicz, San Diego, CA (US)

(73) Assignee: QUALCOMM INCORPORATED, San Diego, CA (US)

(21) Appl. No.: 13/727,031

(22) Filed: Dec. 26, 2012

Related U.S. Application Data
(60) Provisional application No. 61/580,981, filed on Dec. 28, 2011.

(51) Int. Cl. H04N 7/26

(52) U.S. Cl. CPC H04N 19/0089
USPC 375/240.25

(57) ABSTRACT

In one example, a video coding device is configured to decode four blocks of video data, wherein the four blocks are non-overlapping and share one common point such that four edge segments are formed by the four blocks, for each of the four edge segments, determine whether to deblock the respective edge segment based on a first analysis of at least one line of pixels that is perpendicular to the respective edge segment and that intersects the respective edge segment, for each of the four edge segments that was determined to be deblocked, determine whether to apply a strong filter or a weak filter to the respective edge segment based on a second analysis of the at least one line of pixels for the respective edge, and deblock the four edge segments based on the determinations.

This application claims the benefit of U.S. Provisional Application Ser. No. 61/580,981, filed Dec. 28, 2011, which is hereby incorporated by reference in its entirety.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4 Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

In general, this disclosure describes techniques for deblocking of video data. In particular, this disclosure describes techniques for reducing the complexity of deblocking decisions. Video coding is performed on block-based units, which may be individually coded. The coding process may introduce variations in neighboring blocks of a frame of video data. The techniques of this disclosure aim to reduce the complexity in determining whether to deblock edges between blocks of video data. Reduction in the complexity of these decisions may reduce coding complexity, improve processor utilization and efficiency, and/or improve battery life for mobile devices implementing video coding units.

In one example, a method includes decoding a number of blocks of video data, wherein the blocks are non-overlapping and share one common point such that the same number of edge segments are formed by the blocks, for each of the edge segments, determining whether to deblock the respective edge segment based on a first analysis of at least one line of pixels that is perpendicular to the respective edge segment and that intersects the respective edge segment, for each of the edge segments that was determined to be deblocked, determining whether to apply a strong filter or a weak filter to the respective edge segment based on a second analysis of the at least one line of pixels for the respective edge, and deblocking the edge segments based on the determinations.

In another example, a device for coding video data includes a video coder configured to decode a number of blocks of video data, wherein the blocks are non-overlapping and share one common point such that the same number of edge segments are formed by the blocks, for each of the edge segments, determining whether to deblock the respective edge segment based on a first analysis of at least one respective line of pixels that is perpendicular to the respective edge segment and that intersects the respective edge segment, for each of the edge segments that was determined to be deblocked, determining whether to apply a strong filter or a weak filter to the respective edge segment based on a second analysis of the at least one respective line of pixels for the respective edge segment, and deblock one or more of the edge segments based on the determinations.

In another example, a device for coding video data includes means for decoding a number of blocks of video data, wherein the blocks are non-overlapping and share one common point such that the same number of edge segments are formed by the blocks, means for determining, for each of the edge segments, whether to deblock the respective edge segment based on a first analysis of at least one respective line of pixels that is perpendicular to the respective edge segment and that intersects the respective edge segment, means for determining, for each of the edge segments that was determined to be deblocked, whether to apply a strong filter or a weak filter to the respective edge segment based on a second analysis of the at least one respective line of pixels for the respective edge segment, and means for deblocking one or more of the edge segments based on the determinations.

In another example, a computer-readable storage medium has stored thereon instructions that, when executed, cause a processor to decode a number of blocks of video data, wherein the blocks are non-overlapping and share one common point such that the same number of edge segments are formed by the blocks, for each of the edge segments, determine whether to deblock the respective edge segment based on a first analysis of at least one respective line of pixels that is perpendicular to the respective edge segment and that intersects the respective edge segment, for each of the edge segments that was determined to be deblocked, determine whether to apply a strong filter or a weak filter to the respective edge segment based on a second analysis of the at least one respective line of pixels for the respective edge segment, and deblock one or more of the edge segments based on the determinations.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example video encoding and decoding system that may utilize techniques for performing simplified deblocking decisions.

FIG. 2 is a block diagram illustrating an example of video encoder that may implement techniques for performing simplified deblocking decisions.

FIG. 3 is a block diagram illustrating an example of video decoder that may implement techniques for performing simplified deblocking decisions.

FIG. 4 is a block diagram illustrating components of an example de-blocker.

FIG. 5 is a conceptual diagram illustrating pixel positions of four example blocks separated by edge segments.

FIGS. 6A-6D are conceptual diagrams illustrating various examples of lines of pixels that may be analyzed in accordance with the techniques of this disclosure, when performing deblocking decisions.

FIG. 7 is a flowchart illustrating an example method for deblocking boundaries between blocks in parallel in accordance with the techniques of this disclosure.

### DETAILED DESCRIPTION

This disclosure describes techniques related to deblocking of video data. That is, after dividing a frame of video data into blocks (largest coding units (LCUs) and sub-CUs thereof), coding the blocks, and then decoding the blocks, perceptible artifacts at edges between the blocks may occur. Therefore, video encoders may encode video data of a frame, then subsequently decode the encoded video data, and then apply one or more deblocking filters to the decoded video data for use as reference video data. Reference data may be data from one or more frames that a video encoder may use, for example, for inter-prediction of subsequently coded video data. A video encoder may store one or more frames within a reference frame store for inter-prediction. Likewise, a video decoder may store frames for inter-prediction in a similar manner.

Performance of deblocking filtering by a video coding device, such as a video encoder or video decoder, prior to storing the decoded video data for use as reference data, is generally referred to as “in-loop” filtering. In “in-loop” filtering, a video encoder or decoder may perform the de-blocking within a video loop such that deblock filtered data is used for predicting later blocks. The techniques may also be applicable to “post loop” deblock filtering, in which case the deblock filtered data is output for display, but unfiltered data is used for predicting later blocks.

Video encoders may begin with receiving raw video data, encoding the video data, de-blocking the data, and storing de-blocked frames in a reference frame store. Video decoders may be configured to decode received video data, and then apply the same deblocking filters to the decoded video data, for purposes of displaying the video data as well as for use as reference for subsequent video data to be decoded. By configuring both encoders and decoders to apply the same deblocking techniques, the encoders and decoders can be synchronized, such that deblocking does not introduce error for subsequently coded video data using the deblocked video data for reference.

An unpartitioned CU (that is, a leaf-node CU) may include one or more prediction units (PUs) and/or transform units (TUs), which may each be further subdivided. PUs and/or TUs may be divided into rectangular or square regions separated by an edge that may introduce perceptible blockiness artifacts. A video encoder or decoder configured in accordance with the techniques described in HM may generally determine whether to apply a deblocking filter to deblock boundaries at an intersection, e.g., along four edge sections where four blocks meet at one point. The video encoder or decoder configured according to the techniques of HM may be configured to determine whether to deblock the edges based on an analysis of two lines of pixels per edge section.

The techniques of this disclosure may further reduce the complexity of deblocking. These techniques may be performed to determine, in parallel, whether any or all of four edge segments occurring at the intersection between horizontal and vertical edges of adjacent blocks should be deblocked. Assuming, for example, that respective corners of four blocks intersect at a single point, four pixels along a horizontal boundary and four pixels along a vertical boundary, centered at the single point, may define an 8×8 pixel square including pixels used in determining whether to deblock the edge segments and used to deblock those edge segments for which deblocking is determined. Accordingly, each edge segment may be four pixels in length.

One line of pixels per edge segment, perpendicular to the corresponding edge segment, may be analyzed to determine whether the corresponding edge segment should be deblocked. Moreover, the deblocking decisions for each of the edge segments may be made in parallel, before actually deblocking the edges themselves. The deblocking decision may further indicate whether a strong or weak deblocking filter should be applied to deblock edges for which deblocking is determined. When a weak filter is selected, the deblocking decision may also determine whether to modify one or two samples of the deblocking filter, representative of a width of the deblocking process.

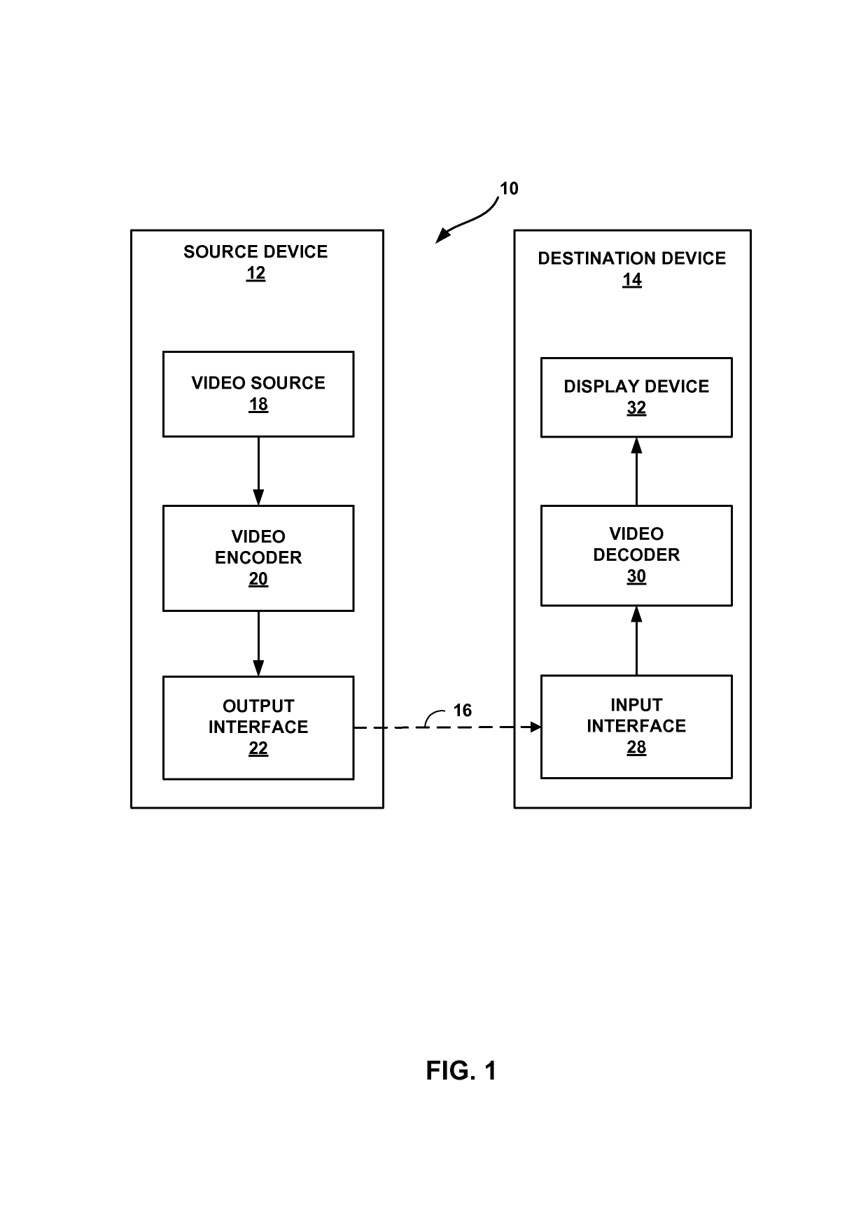

FIG. 1 is a block diagram illustrating an example video encoding and decoding system 10 that may utilize techniques for performing simplified deblocking decisions. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for performing simplified deblocking decisions. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for performing simplified deblocking decisions may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video compression standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video compression standards include MPEG-2 and ITU-T H.263. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

Video encoder 20 and video decoder 30 may implement simplified techniques for deblocking of video data, in accordance with this disclosure. For example, either or both of video encoder 20 and video decoder 30 may implement a method including decoding four blocks of video data, wherein the four blocks are non-overlapping and share one common point such that four edge segments are formed by the four blocks, for each of the four edge segments, determining whether to deblock the respective edge segment based on a first analysis of at least one respective line of pixels that is perpendicular to the respective edge segment and that intersects the respective edge segment, for each of the four edge segments that was determined to be deblocked, determining whether to apply a strong filter or a weak filter to the respective edge segment based on a second analysis of the at least one respective line of pixels for the respective edge, and deblocking one or more of the four edge segments based on the determinations.

Although generally described as relating to decoding four blocks of video data and performing deblocking processes on four edges formed by the four blocks (e.g., determining whether to deblock the four edges, determining deblocking filters, and determining filter strengths), the techniques of this disclosure may also be applied to other numbers of blocks. For example, three neighboring blocks may intersect at a common point, where two of the blocks may be similarly sized and the third block is twice as large as the other two blocks, which may form three edges, rather than four. Likewise, these techniques may be used for two edge segments formed by two neighboring blocks, where the two edge segments may form a common line, but may be separately analyzed.

In particular, video decoder 30 is generally configured to decode all received blocks of video data. Video encoder 20 is also configured to decode blocks of video data following encoding. That is, video encoder 20 decodes encoded blocks in order to use the decoded blocks as reference blocks for subsequently coded video data, e.g., using intra-prediction or inter-prediction. Therefore, video encoder 20 may be configured to encode the four video blocks prior to decoding the four video blocks.

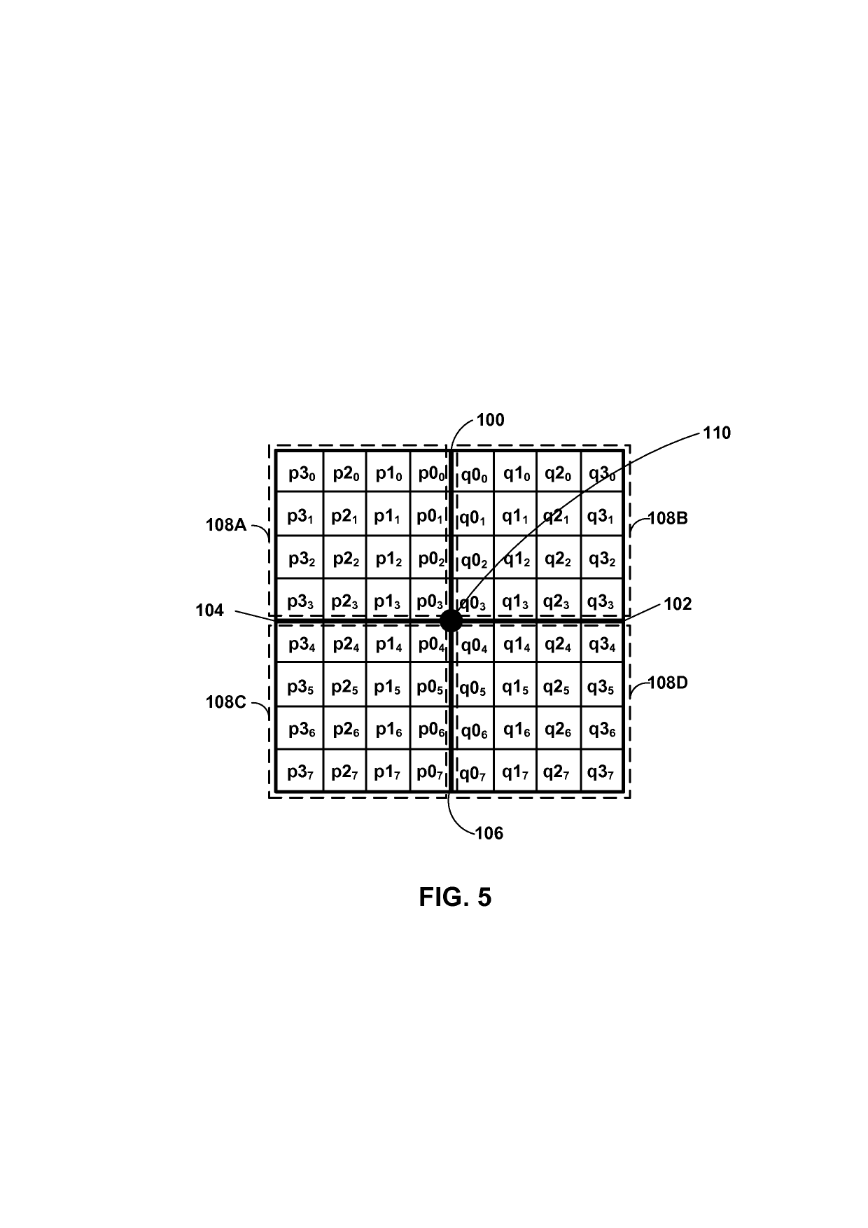

As explained in greater detail below, FIG. 5 illustrates an example of four such video blocks that are non-overlapping and share one common point such that four edge segments are formed by the four blocks. The common point is not necessarily a pixel of any of the four video blocks, but instead, an intersection for the four edge segments, as shown in FIG. 5. Likewise, the edge segments are not necessarily sets of pixels of the four video blocks, but may occur between pixels of the four video blocks, as shown in FIG. 5.

The line of pixels that is analyzed to determine whether to deblock pixels along an edge segment may comprise a line of pixels that intersects the edge segment at a point that is a certain number of pixels away from the common point at which the four blocks meet. For example, the number of pixels, i, may be any value between 0 (representing the line of pixels closest to the common point) and N (representing the furthest line of pixels away from the common point that still intersects the edge segment, assuming the edge segment has a length of N+1 pixels).

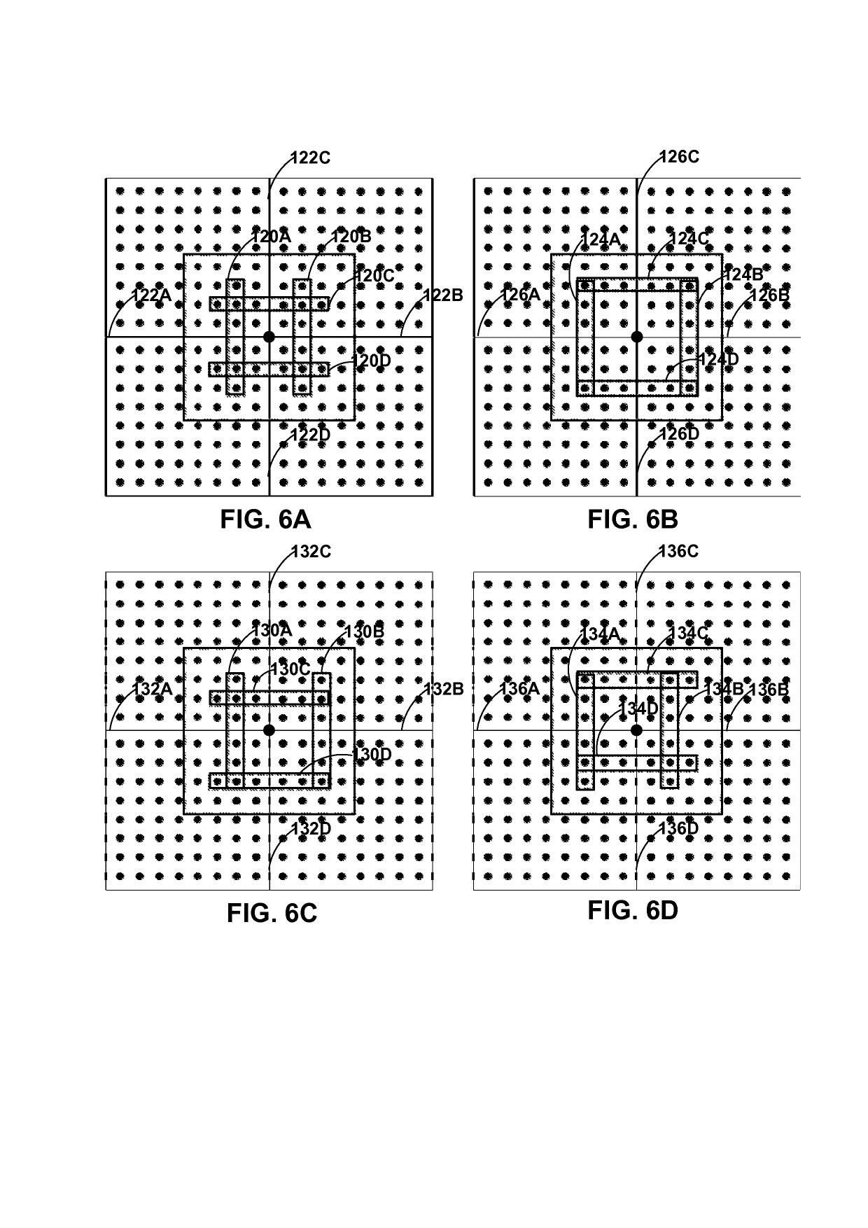

In addition, the same value of i may be used for each edge segment. This may result in a cross shape formed by the lines of pixels that are analyzed to determine whether to deblock each edge segment and the strength of filters used to deblock the edge segments. Examples of the same value of i being used for each edge segment as a distance from the common point are shown in FIGS. 6A and 6B. FIG. 6A specifically illustrates an example of the cross shape discussed above. Alternatively, each line of pixels used to analyze respective edge segments may be the same distance from a certain edge of a respective block, e.g., a left edge or a top edge of the block. Examples in which the line of pixels is the same distance from a certain edge are shown in FIGS. 6C and 6D.

Video encoder 20 and video decoder 30 may be configured to determine whether to deblock each edge segment based on a first analysis of at least one line of pixels that is perpendicular to the edge segment and that intersects the edge segment. Various examples of such perpendicular lines of pixels that intersect edge segments are shown in FIGS. 6A-6D, discussed in greater detail below. Rather than analyzing all perpendicular intersecting lines of pixels relative to an edge segment, video encoder 20 and video decoder 30 may simply analyze one line of pixels that is perpendicular to and intersects an edge segment. In this manner, video encoder 20 and video decoder 30 may utilize fewer processing resources during a determination of whether to deblock an edge segment. Moreover, video encoder 20 and video decoder 30 may perform a substantially similar analysis for all four edge segments of the four video blocks that form the four edge segments. Video encoder 20 and video decoder 30 may perform the first analysis for each of the four edge segments substantially in parallel, i.e., substantially simultaneously using parallel processing cores or threads.

Video encoder 20 and video decoder 30 may further determine, for each edge segment to be deblocked, whether to apply a strong filter or a weak filter to the respective edge segment based on a second analysis of the line of pixels that is perpendicular to and intersects the edge segment. Video encoder 20 and video decoder 30 may perform this second analysis for the four edge segments substantially in parallel as well. Strong or weak filtering generally indicates a degree of modification to pixels near the edge segment. That is, a strong filter modifies values of pixels near the edge segment to a greater degree than a weak filter. Filtering pixels near the edge segment generally involves modifying values of one or more pixels on either or both sides of the edge segment, e.g., two pixels on each side of the edge segment along the full length of the edge segment. Thus, although the analysis of whether to deblock an edge segment, and whether to deblock the edge segment using a strong or weak filter, may involve only one line of pixels intersecting and perpendicular to the edge segment, the actual filtering of the edge segment may be applied to all lines of pixels intersecting and perpendicular to the edge segment.

Furthermore, in some examples, video encoder 20 and video decoder 30 determine a filter width when a weak filter is selected. The filter width generally indicates a number of pixels to be modified during deblocking. For example, when video encoder 20 and video decoder 30 determine to apply a weak filter to an edge segment, video encoder 20 and video decoder 30 may further determine whether to modify one or two pixels on either or both sides of the edge segment, e.g., two pixels on both sides, one pixel on both sides, or two pixels on one side and one pixel on the other side. The number of pixels to be modified is not necessarily the same as the number of pixels read by the filter to modify the pixels to be modified. For example, three pixels on each side of the edge segment may be read (that is, used as input to the filter), but the filter may only modify one or two pixels on either or both sides of the edge segment.

As another example, either or both of video encoder 20 and video decoder 30 may implement a method including decoding four blocks of video data, wherein the four blocks are non-overlapping and share one common point such that four edge segments are formed by the four blocks, for each of the four edge segments, determining whether to deblock the respective edge segment based on a first analysis of a respective line of pixels that is perpendicular to the respective edge segment and at least one Laplacian value for the respective line of pixels compared to a threshold value, for each of the four edge segments that was determined to be deblocked, determining whether to apply a strong filter or a weak filter to the respective edge segment based on a second analysis comprising, determining a first binary value representative of a comparison of the respective line of pixels and the Laplacian value to one-half of the threshold value, determining a second binary value representative of whether |p3ᵢ−p0ᵢ|+|q0ᵢ−q3ᵢ| is less than one-quarter of the threshold, determining a third binary value representative of whether |p0ᵢ−q0ᵢ|<((5*t_{c}+1)/2, and determining whether to apply the strong filter or the weak filter based on a binary AND operation over the first binary value, the second binary value, and the third binary value, and deblocking the four edge segments based on the determinations.

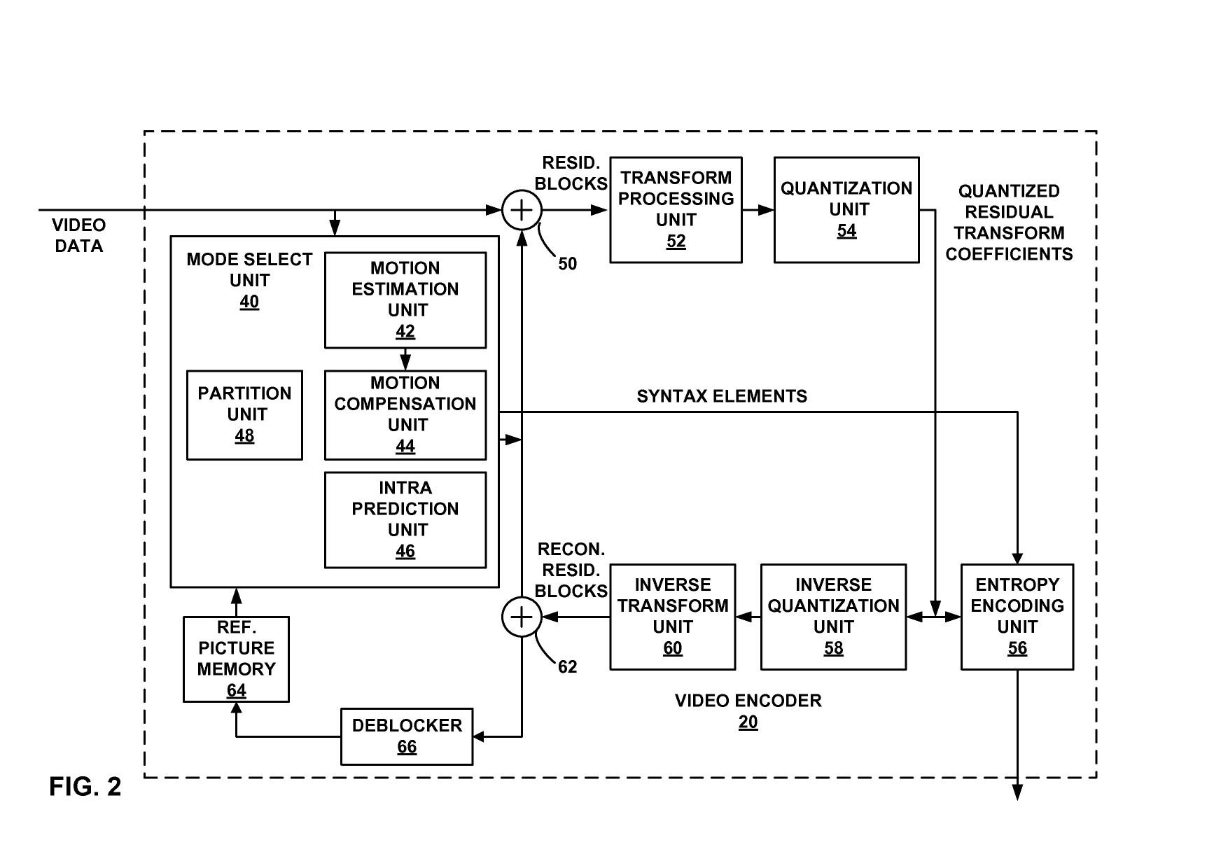

FIG. 2 is a block diagram illustrating an example of video encoder 20 that may implement techniques for performing simplified deblocking decisions. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video frame to be encoded. In the example of FIG. 2, video encoder 20 includes mode select unit 40, reference picture memory 64, summer 50, transform processing unit 52, quantization unit 54, entropy encoding unit 56, and deblocker 66. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra-prediction unit 46 may alternatively perform intra-predictive coding of the received video block relative to one or more neighboring blocks in the same frame or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

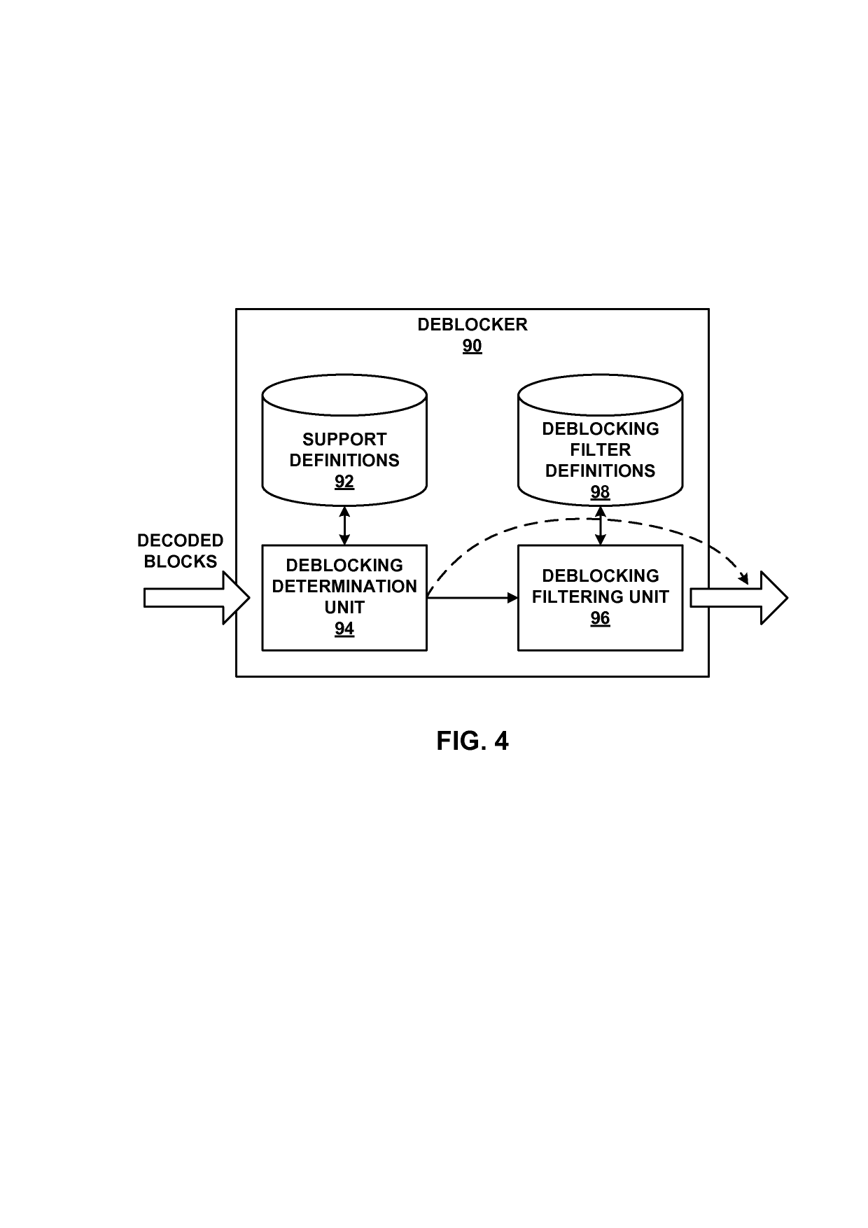

In accordance with the techniques of this disclosure, video encoder 20 includes deblocker 66 that selectively filters the output of summer 62. In particular, deblocker 66 receives reconstructed video data from summer 62, which corresponds to predictive data received from either motion compensation unit 44 or intra-prediction unit 46, added to inverse quantized and inverse transformed residual data. In this manner, deblocker 66 receives decoded blocks of video data, e.g., CUs of an LCU, LCUs of a slice or frame, PUs of a CU, and/or TUs of a CU. In general, deblocker 66 selectively filters the blocks of video data, e.g., using the simplified parallel deblocking decision techniques of this disclosure. For example, deblocker 66 may determine whether to apply a deblocking filter to each of four edge segments near an intersection of edges (i.e., at a common point between four blocks forming the four edge segments). In response to determining that an edge segment should be deblocked, deblocker 66 may determine whether to deblock the edge using a weak or a strong filter, and for weak filters, whether to modify one or two samples of the filter. FIG. 4, described in greater detail below, illustrates one example of a deblocker to which deblocker 66 may conform.

In accordance with the techniques of this disclosure, deblocker 66 may determine whether to deblocking filter edge segments between four neighboring blocks (an upper-left, an upper-right, a lower-left, and a lower-right block) in parallel through an analysis of one perpendicular, intersecting line of pixels per edge segment formed by the four blocks. Deblocker 66 may also use the same lines of pixels to determine whether to apply a strong or weak filter to the edge segments that were determined to be deblocked. Moreover, deblocker 66 may use the same lines of pixels to determine, for edge segments to which weak filters are to be applied, a width of the weak filters.

The four lines that intersect the edge segments may form a cross shape, in some examples. For example, the four lines may each be two pixels away from a common point at which the four edge segments meet (that is, at a common point of the four blocks). Assuming that the four lines analyzed by deblocker 66 are six pixels long, three pixels on either side of the respective edge segment intersected by the lines, then if the four lines are two pixels away, the four lines form four cross shapes within the four respective blocks, e.g., as shown in FIG. 6A. Alternatively, the four lines may form a block shape, e.g., as shown in FIG. 6B.

Deblocker 66 may calculate a value representative of boundary strength of the edge segments of the four blocks, represented by β (beta) in this disclosure. For each of the four edge segments formed by the four blocks, deblocker 66 may calculate a value representing a mathematical combination of values of pixels along the line that is perpendicular to and intersects the edge segment. Deblocker 66 may then compare the calculated value to β, or a value representative of β (e.g., β/2) to determine whether to deblock the edge segment. Moreover, deblocker 66 may perform these calculation and comparison operations for the four edge segments substantially in parallel. The comparison may yield a binary value indicative of whether to perform deblocking of the edge segment. For example, if the calculated value is less than β/2, then deblocker 66 may determine to deblock the edge segment; otherwise, deblocker 66 may determine not to deblock the edge segment.

Following determinations of which of the four edge segments are to be deblocked, deblocker 66 may calculate a second set of values, again representing mathematical combinations of values of the pixels along the lines of pixels that intersect the edge segments, and compare these values to another value representative of a function of β (e.g., β/4). Using these calculation and comparison operations, deblocker 66 may determine whether to apply a strong or a weak filter to the edge segments that were determined to be deblocked. Deblocker 66 may perform these calculation and comparison operations substantially in parallel, and these operations may yield independent determinations for each of the edge segments that were determined to be deblocked.

Subsequently, deblocker 66 may calculate yet another set of values representing mathematical combinations of the values of the pixels along the lines that intersect and are perpendicular to the edge segments. In particular, for those edge segments to be deblocked using a weak filter, deblocker 66 may use this subsequent set of combination and comparison operations to determine a width of the weak filter. Yet again, these operations may be performed in parallel and yield independent determinations for each of the edge segments to be deblocked using a weak filter.

Following the determinations of which edge segments are to be deblocked, types of filters (strong or weak) to use to deblock the edge segments, and widths for weak filters, deblocker 66 may deblock the edge segments in accordance with the determinations. For example, deblocker 66 may apply a strong filter to edge segments for which a strong filter was determined, and a weak filter of a determined width to edge segments for which a weak filter was determined. In this manner, after determining to deblock an edge segment forming a boundary, deblocker 66 modifies one or more pixels (that is, values of the pixels) near the boundary to smooth a transition at the boundary, which may reduce the likelihood that a viewer will perceive a blockiness artifact at the boundary.

Furthermore, as shown in FIG. 2, deblocker 66 outputs deblocked (that is, filtered) video data to reference picture memory 64. Thus, mode select unit 40 may use deblocked (filtered) video data for use as reference video data when encoding subsequent video data. In this manner, deblocker 66 may be referred to as an “in-loop” filter, in that deblocker 66 performs deblocking and filtering of video data during the video coding loop.

In this manner, video encoder 20 of FIG. 2 represents an example of a video encoder that implements a method including decoding four blocks of video data, wherein the four blocks are non-overlapping and share one common point such that four edge segments are formed by the four blocks, for each of the four edge segments, determining whether to deblock the respective edge segment based on a first analysis of at least one line of pixels that is perpendicular to the respective edge segment and that intersects the respective edge segment, for each of the four edge segments that was determined to be deblocked, determining whether to apply a strong filter or a weak filter to the respective edge segment based on a second analysis of the at least one line of pixels for the respective edge, and deblocking the four edge segments based on the determinations.

Video encoder 20 also represents an example of a video encoder that implements a method including decoding four blocks of video data, wherein the four blocks are non-overlapping and share one common point such that four edge segments are formed by the four blocks, for each of the four edge segments, determining whether to deblock the respective edge segment based on a first analysis of a respective line of pixels that is perpendicular to the respective edge segment and at least one Laplacian value for the respective line of pixels compared to a threshold value, for each of the four edge segments that was determined to be deblocked, determining whether to apply a strong filter or a weak filter to the respective edge segment based on a second analysis comprising determining a first binary value representative of a comparison of the respective line of pixels and the Laplacian value to one-half of the threshold value, determining a second binary value representative of whether |p3ᵢ−p0ᵢ|+|q0ᵢ−q3ᵢ| is less than one-quarter of the threshold, determining a third binary value representative of whether |p0ᵢ−q0ᵢ|<((5*t_{c}+1)/2, and determining whether to apply the strong filter or the weak filter based on a binary AND operation over the first binary value, the second binary value, and the third binary value, and deblocking the four edge segments based on the determinations.

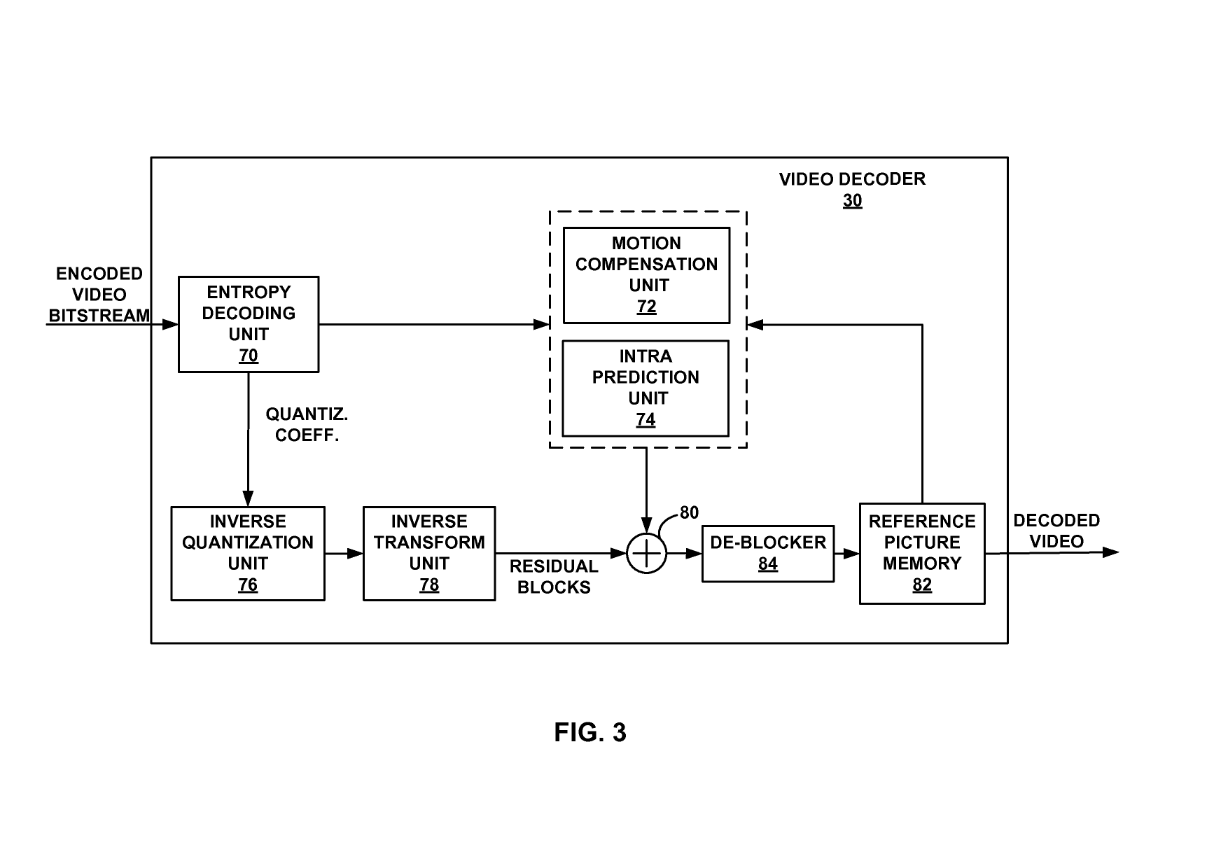

FIG. 3 is a block diagram illustrating an example of video decoder 30 that may implement techniques for performing simplified deblocking decisions. In the example of FIG. 3, video decoder 30 includes an entropy decoding unit 70, motion compensation unit 72, intra prediction unit 74, inverse quantization unit 76, inverse transformation unit 78, reference picture memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

In accordance with the techniques of this disclosure, video decoder 30 includes deblocker 84 that selectively filters the output of summer 80. In particular, deblocker 84 receives reconstructed video data from summer 80, which corresponds to predictive data received from either motion compensation unit 72 or intra-prediction unit 74, added to inverse quantized and inverse transformed residual data. In this manner, deblocker 84 receives decoded blocks of video data, e.g., CUs of an LCU, LCUs of a slice or frame, PUs of a CU, and/or TUs of a CU. In general, deblocker 84 selectively filters the blocks of video data, e.g., using the simplified deblocking decision techniques of this disclosure. For example, deblocker 84 may determine whether to deblocking filter each of four edge segments near an intersection of edges. In response to determining that an edge segment should be deblocked, deblocker 84 may determine whether to deblock the edge using a weak or a strong filter, and for weak filters, whether to modify one or two samples of the filter.

In accordance with the techniques of this disclosure, deblocker 84 may determine whether to deblocking filter edge segments between four neighboring blocks (an upper-left, an upper-right, a lower-left, and a lower-right block) in parallel through an analysis of one perpendicular, intersecting line of pixels per edge segment formed by the four blocks. Deblocker 84 may also use the same lines of pixels to determine whether to apply a strong or weak filter to the edge segments that were determined to be deblocked. Moreover, deblocker 84 may use the same lines of pixels to determine, for edge segments to which weak filters are to be applied, a width of the weak filters.

The four lines that intersect the edge segments may form a cross shape, in some examples. For example, the four lines may each be two pixels away from a common point at which the four edge segments meet (that is, at a common point of the four blocks). Assuming that the four lines analyzed by deblocker 84 are six pixels long, with three pixels on either side of the respective edge segment intersected by the lines, then if the four lines are two pixels away, the four lines form four cross shapes within the four respective blocks, e.g., as shown in FIG. 6A. Alternatively, the four lines may form a block shape, e.g., as shown in FIG. 6B. Of course, other shapes are also possible, such as those shown in FIGS. 6C and 6D.

Deblocker 84 may calculate a value representative of boundary strength of the edge segments of the four blocks, represented by β (beta) in this disclosure. For each of the four edge segments formed by the four blocks, deblocker 84 may calculate a value representing a mathematical combination of values of pixels along the line that is perpendicular to and intersects the edge segment. Deblocker 84 may then compare the calculated value to β, or a value that varies as a function of β (e.g., β/2) to determine whether to deblock the edge segment. Moreover, deblocker 84 may perform these calculation and comparison operations for the four edge segments substantially in parallel. The comparison may yield a binary value indicative of whether to perform deblocking of the edge segment. For example, if the calculated value is less than β/2, then deblocker 84 may determine to deblock the edge segment; otherwise, deblocker 84 may determine not to deblock the edge segment.

Following determinations of which of the four edge segments are to be deblocked, deblocker 84 may calculate a second set of values, again representing mathematical combinations of values of the pixels along the lines of pixels that intersect the edge segments, and compare these values to another value representative of β (e.g., β/4). Using these calculation and comparison operations, deblocker 84 may determine whether to apply a strong or a weak filter to the edge segments that were determined to be deblocked. Deblocker 84 may perform these calculation and comparison operations substantially in parallel, and these operations may yield independent determinations for each of the edge segments that were determined to be deblocked.

Subsequently, deblocker 84 may calculate yet another set of values representing mathematical combinations of the values of the pixels along the lines that intersect and are perpendicular to the edge segments. In particular, for those edge segments to be deblocked using a weak filter, deblocker 84 may use this subsequent set of combination and comparison operations to determine a width of the weak filter. Yet again, these operations may be performed in parallel and yield independent determinations for each of the edge segments to be deblocked using a weak filter.

Following the determinations of which edge segments are to be deblocked, types of filters (strong or weak) to use to deblock the edge segments, and widths for weak filters, deblocker 84 may deblock the edge segments in accordance with the determinations. For example, deblocker 84 may apply a strong filter to edge segments for which a strong filter was determined, and a weak filter of a determined width to edge segments for which a weak filter was determined. In this manner, after determining to deblock an edge segment forming a boundary, deblocker 84 modifies one or more pixels (that is, values of the pixels) near the boundary to smooth a transition at the boundary, which may reduce the likelihood that a viewer will perceive a blockiness artifact at the boundary.

Furthermore, as shown in FIG. 3, deblocker 84 outputs deblocked (that is, filtered) video data to reference picture memory 82. Thus, motion compensation unit 72 and intra-prediction unit 74 may use deblocked (filtered) video data for use as reference video data when decoding subsequent video data. In this manner, deblocker 84 may be referred to as an “in-loop” filter, in that deblocker 84 performs deblocking and filtering of video data during the video coding loop.

In this manner, video decoder 30 of FIG. 3 represents an example of a video decoder that implements a method including decoding four blocks of video data, wherein the four blocks are non-overlapping and share one common point such that four edge segments are formed by the four blocks, for each of the four edge segments, determining whether to deblock the respective edge segment based on a first analysis of at least one line of pixels that is perpendicular to the respective edge segment and that intersects the respective edge segment, for each of the four edge segments that was determined to be deblocked, determining whether to apply a strong filter or a weak filter to the respective edge segment based on a second analysis of the at least one line of pixels for the respective edge, and deblocking the four edge segments based on the determinations.

Video decoder 30 also represents an example of a video decoder that implements a method including decoding four blocks of video data, wherein the four blocks are non-overlapping and share one common point such that four edge segments are formed by the four blocks, for each of the four edge segments, determining whether to deblock the respective edge segment based on a first analysis of a respective line of pixels that is perpendicular to the respective edge segment and at least one Laplacian value for the respective line of pixels compared to a threshold value, for each of the four edge segments that was determined to be deblocked, determining whether to apply a strong filter or a weak filter to the respective edge segment based on a second analysis comprising, determining a first binary value representative of a comparison of the respective line of pixels and the Laplacian value to one-half of the threshold value, determining a second binary value representative of whether |p3ᵢ−p0ᵢ|+|q0ᵢ−q3ᵢ| is less than one-quarter of the threshold, determining a third binary value representative of whether |p0ᵢ−q0ᵢ|<((5*t_{c}+1)/2, and determining whether to apply the strong filter or the weak filter based on a binary AND operation over the first binary value, the second binary value, and the third binary value, and deblocking the four edge segments based on the determinations.

FIG. 4 is a block diagram illustrating components of an example deblocker 90. In general, either or both of deblocker 66 (FIG. 2) and deblocker 84 (FIG. 3) may include components substantially similar to those of deblocker 90. Other video coding devices, such as video encoders, video decoders, video encoder/decoders (CODECs), and the like may also include components substantially similar to deblocker 90. Deblocker 90 may be implemented in hardware, software, or firmware. When implemented in software or firmware, corresponding hardware (such as one or more processors or processing units and memory for storing instructions for the software or firmware) may also be provided.

In the example of FIG. 4, deblocker 90 includes deblocking determination unit 94, support definitions 92, deblocking filtering unit 96, and deblocking filter definitions 98. Any or all of the components of deblocker 90 may be functionally integrated. The components of deblocker 90 are illustrated separately only for purposes of illustration. In general, deblocker 90 receives data for decoded blocks, e.g., from a summation component, such as unit 62 (FIG. 2) or unit 80 (FIG. 3), that combines prediction data with residual data for the blocks.

Deblocking determination unit 94 may apply the techniques of this disclosure for simplified determinations of whether to deblock edge segments. In some examples, deblocking determination unit 94 may perform these deblocking determinations in parallel, or substantially in parallel. That is, deblocking determination unit 94 may execute a multithreaded software program with one thread devoted to each edge segment and/or may include separate hardware components, i.e., processors or processing cores, for analyzing each edge segment. In this manner, the deblocking decisions may be performed substantially simultaneously, e.g., substantially in parallel.

In accordance with the techniques of this disclosure, deblocker 90 may be configured to receive four decoded blocks of video data that neighbor each other and meet at a common point. For example, the four blocks may include an upper-left block, an upper-right block, a lower-left block, and a lower-right block. The common point for these four blocks may correspond to a lower-right corner of the upper-left block, a lower-left corner of the upper-right block, an upper-right corner of the lower-left block, and an upper-left corner of the lower-right block. The four blocks may further define four edge segments, corresponding to boundaries between the blocks that extend away from the common point at which the edge segments meet. For example, the upper-left and upper-right blocks may define an upper edge segment extending up from the common point, the upper-left and lower-left blocks may define a left edge segment extending to the left from the common point, the lower-left and lower-right blocks may define a lower edge segment extending down from the common point, and the lower-right and upper-right blocks may define a right edge segment extending to the right from the common point.

Deblocker 90 may be configured to analyze lines of pixels perpendicular to and intersecting the respective edge segments to determine whether to deblock any or all of the edge segments, whether to apply a weak or strong filter to the edge segments to be deblocked, and widths of weak filters. Deblocker 90 may be configured to make each of these determinations in parallel. That is, deblocker 90 may make deblocking decisions in parallel, filter strength determinations in parallel, and filter width determinations in parallel.

In particular, deblocking determination unit 94 may be configured to make these various determinations (i.e., whether to deblock an edge segment, whether to apply a strong or weak filter to deblock the edge segment, and a width of a weak filter when a weak filter is selected). Support definitions 92 includes data defining the lines of pixels to be used to make these determinations. Support definitions 92 may include, for example, an indication that lines of pixels that are two pixels away from the common point, and six pixels long, are to be used to make the various determinations. In this manner, support definitions 92 may include data indicating that the lines of pixels to be analyzed form cross shapes in the respective four blocks, such as shown in FIG. 6A. Additionally or alternatively, support definitions 92 may include data indicating that the lines of pixels to be analyzed form a box shape around the common point, such as shown in FIG. 6B. Support definitions 92 may also include data indicative of other shapes, such as those shown in FIGS. 6C and 6D. Examples of support defined by support definitions 92, and techniques which deblocking determination unit 94 may use to determine whether to deblock an edge segment and to select a filter to use to deblock an edge segment, are described in greater detail with respect to FIG. 5 below.

Deblocking filter definitions 98 define various deblocking filters, such as strong filters and weak filters of various widths. The widths of weak filters may include weak filters that modify one pixel on each side of a boundary, two pixels on each side of a boundary, and one pixel on one side and two pixels on the other side of a boundary. The number of pixels modified by a deblocking filter is not necessarily the same as the number of pixels used as input to the deblocking filter. Thus, deblocking filter definitions 98 may include data defining a number of inputs to a deblocking filter, as well as data defining a number of pixels to be modified using the inputs. In general, a deblocking filter is defined by input pixels and filter coefficients to be mathematically applied to the input pixels to produce modified values of certain pixels.

Deblocking filtering unit 96 performs the deblocking filtering of the four boundaries (that is, edge segments) formed by four neighboring blocks in accordance with the techniques of this disclosure. Deblocking determination unit 94 provides data indicating which edge segments are to be deblocked, types of filters (e.g., strong or weak) and widths of weak filters to be applied to the various edge segments. Deblocking filtering unit 96 uses the data received from deblocking determination unit 94, as well as the filters defined in deblocking filter definitions 98, to determine whether and how to modify pixel values near edge segments.

FIG. 5 is a conceptual diagram illustrating pixel positions of four example blocks 108A-108D, separated by edge segments 100, 102, 104, and 106. Each of edge segments 100-106 has a length of four pixels in this example. Blocks 108A-108D represent examples of four neighboring, non-overlapping blocks that share common point 110 such that four edge segments (edge segments 100-106) are formed by the four blocks.

In this example, each of edge segments 100-106 has its own set of deblocking decisions, e.g., whether to be deblocked, and if so, whether to use a strong or weak deblocking filter, and if weak, how many samples to modify on either side of the corresponding edge segment. In some examples, vertical edge segments may be deblocking filtered before horizontal edge segments. For example, support definitions 92 (FIG. 4) may include support definitions for each of edge segments 100-106. Thus, deblocking determination unit 94 may apply the respective support definition of support definitions 92 to edge segments 100-106.

Blocks 108A-108D share a common point 110, in this example. As shown in the example of FIG. 5, common point 110 is not a pixel in this example, but a representation of a point at which blocks 108A-108D meet. Each of the pixel positions is designated using the format [p|q]IJ, where p corresponds to pixels on the left of edge segments 100 and 106, q corresponds to pixels on the right of edge segments 100 and 106, I corresponds to a distance from edge segments 100 and 106, and J corresponds to a row indicator from top to bottom. A line of pixels may also be said to be a certain number of pixels away from common point 110. For example, the line of pixels including pixels p2₃, p1₃, p0₃, q0₃, q1₃, q2₃ is one pixel from common point 110, in that this line of pixels is the first line of pixels above common point 110.

In some examples, when determining deblocking decisions for a particular one of edge segments 100, 102, 104, 106, at least one line (perpendicular to the respective edge segment) may be analyzed. This may reduce the computational complexity of deblocking decisions, e.g., by one-half. For example, only rows/columns of pixels that are two pixels away from common point 110 might be used when making deblocking decisions. For example, for edge segment 100, deblocker 90 might only analyze a line including pixels p2₁, p1₁, p0₁, q0₁, q1₁, and q2₁.

In one example, let:

dpᵢ=|p2ᵢ−2*p1ᵢ+p0ᵢ|,

dqᵢ=|q0ᵢ−2*q1ᵢ+q2ᵢ|, and

dᵢ=(dpᵢ+dqᵢ).

In this example, deblocker 90 may compare the value of dᵢ to a threshold value, e.g., Beta (β), which may correspond to a measure of boundary strength, or a value corresponding to β. In one example, deblocking determination unit 94 may determine to deblock edge segment 100 if d₂<β/2, and otherwise, not to deblock edge segment 100. In one example, deblocking determination unit 94 may determine to deblock edge segment 106 if d₅<β/2, and otherwise, not to deblock edge segment 106. The notation above can be easily converted between rows and columns, for an analysis of edge segments 102 and 104. Thus, deblocking determination unit 94 may apply similar analyses to determine whether to deblock edge segments 102 and 104. In this manner, at least one line of pixels, perpendicular to an edge segment, may be analyzed to determine whether to deblock the edge segment. Furthermore, deblocking determination unit 94 may determine whether to deblock each of edge segments 100-106 substantially in parallel, analyzing at least one line of pixels perpendicular to and intersecting respective ones of edge segments 100-106.

After determining that an edge segment is to be deblocked, deblocking determination unit 94 may analyze the same perpendicular line of pixels to determine whether to apply a strong or a weak deblocking filter. In general, a strong deblocking filter may read and write values from (to) pixels that are up to three pixels away from the corresponding edge segment. Weak filters, on the other hand, may read and/or write fewer than three pixels away from the corresponding edge segment, and may write fewer pixels than are read. In some examples, the weak filter may correspond to a modified version of the strong filter, where one or two samples on either or both sides of the corresponding edge are modified in the weak filter, relative to the strong filter.

In one example, let:

swᵢ=(2dᵢ<β/4)AND

[(|p3ᵢ−p0ᵢ|+|q0ᵢ−q3ᵢ|)<(β/8)]AND

[|p0ᵢ−q0ᵢ|<((5*t_{c}+1)/2)].

In this example, “swᵢ” represents the decision of “strong or weak filter” at line of pixels i. Line of pixels i, again, is the line of pixels perpendicular to and intersecting one of edge segments 100-106 at a distance of i pixels from common point 110. In some examples, if (sw₂) is true, then deblocking determination unit 94 may select a strong filter for edge segment 100, and otherwise, select a weak filter for edge segment 100. In some examples, if (sw₅) is true, then deblocking determination unit 94 may select a strong filter for edge segment 106, and otherwise, select a weak filter for edge segment 106. Likewise, again, the rows and columns may be simply reversed to depict analyses for edge segments 102 and 104. That is, there may be symmetry of the locations of lines/columns for the decisions with respect to horizontal and vertical edge segments.

Moreover, in response to determining to use a weak filter, deblocking determination unit 94 may determine the type (that is, width) of weak filter, that is, whether one or two samples are to be modified by the weak filter. In one example, if dpᵢ<(3β/32) then the weak filter has two samples on the “p” pixel side of the edge modified; otherwise, only one sample on the “p” pixel side of the edge is modified. In one example, if dqᵢ<(3β/32), then the weak filter has two samples on the “q” pixel side of the edge modified; otherwise, only one sample on the “q” pixel side of the edge is modified.

As an alternative to the examples above, rather than using rows/columns that are two pixels away from center point 110, rows/columns that are three pixels away from center point 110 may be used. Thus, rows/columns i=1 and i=6 may be used, instead of i=2 and i=5. As yet another alternative, rows/columns i=1 and i=5 may be used, or rows/columns i=2 and i=6 may be used. These various examples are illustrated in greater detail in FIGS. 6A-6D, as discussed below. Other locations for the decisions are also possible.

As yet another alternative to the examples discussed above, deblocking determination unit 94 may take Laplacian values into account, such as one-dimensional or two-dimensional Laplacians. This may simplify the deblocking decisions, and make them more robust. In one example, deblocking determination unit 94 may calculate texture activity based on a cross shape of two one-dimensional Laplacians. For example, let:

dpᵢ⁺=|p2ᵢ−2*p1ᵢ+p0ᵢ|+|p1ᵢ₋₁−2*p1ᵢ+p1ᵢ₊₁|,

dqᵢ⁺=|q0ᵢ−2*q1ᵢ+q2ᵢ|+|q1ᵢ₋₁−2*q1ᵢ+q1ᵢ₊₁|, and

dᵢ⁺=dpᵢ⁺+dqᵢ⁺.

In another example, deblocking determination unit 94 may use two-dimensional Laplacian values. For example, let:

dpᵢ⁺=|p2ᵢ−4*p1ᵢ+p0ᵢ+p1ᵢ₋₁+p1ᵢ₊₁|,

dqᵢ⁺=|q0ᵢ−4*q1ᵢ+q2ᵢ+q1ᵢ₋₁+q1ᵢ₊₁|, and

dᵢ⁺=dpᵢ⁺+dqᵢ⁺.

In either of these examples, if d₂⁺<β, then deblocking determination unit 94 may determine that edge segment 100 is to be deblocked; otherwise, edge segment 100 is not to be deblocked. Similarly, if d₅⁺<β, then deblocking determination unit 94 may determine that edge segment 106 is to be deblocked; otherwise, edge segment 106 is not to be deblocked. Again, rows and columns may be reversed to produce an analysis for edge segments 102 and 104, and other rows/columns may be used, such as i=1, 2, 5, or 6.

Moreover, let:

swᵢ=(dᵢ⁺<β/4)AND

[(|p3ᵢ−p0ᵢ|+|q0ᵢ−q3ᵢ|)<(β/8)]AND

[|p0ᵢ−q0ᵢ|<((5*t_{c}+1)/2)].

Again, in this example, if (sw₂) is true, then deblocking determination unit 94 may select a strong filter for edge segment 100 (assuming that deblocking determination unit 94 had previously determined that edge segment 100 is to be deblocked), and otherwise, select a weak filter for edge segment 100. In some examples, if (sw₅) is true, then deblocking determination unit 94 may select a strong filter for edge segment 106, and otherwise, select a weak filter for edge segment 106 (again, assuming that deblocking determination unit 94 has previously determined to deblock edge segment 106). Likewise, again, the rows and columns may be simply reversed to depict analyses for edge segments 102 and 104.

In response to determining to use a weak filter, deblocking determination unit 94 may further determine the type (or width) of weak filter, that is, whether one or two samples are modified. In one example, if dpᵢ⁺<(3β/16), then the weak filter has two samples on the “p” pixel side of the edge modified; otherwise, only one sample on the “p” pixel side of the edge is modified. In one example, if dqᵢ⁺<(3β/16) then the weak filter has two samples on the “q” pixel side of the edge modified; otherwise, only one sample on the “q” pixel side of the edge is modified.

These techniques may provide a number of advantages. For example, a cross shape, with respect to the lines of pixels used to determine whether to deblock edge segments, may allow for a more robust texture activity analysis in both directions. Also, the partial results of dpi+ and dqi+ calculated for the vertical edge segments (100 and 106) may be reused for the horizontal edge segments (102 and 104). Alternatively, vertical edges horizontal edges may be analyzed separately. That is, deblocking determination unit 94 may first analyze and filter vertical edges, then analyze and filter horizontal edges.

The techniques of this disclosure are generally described with respect to four blocks, such as blocks 108A, 108B, 108C, and 108D, that intersect at common point 110, forming an equal number of edge segments to the number of blocks (e.g., four edge segments in the example of FIG. 5). However, it should be understood that similar techniques may be applied to analyze different numbers of edge segments formed by different numbers of blocks. For example, blocks 108C and 108D in the example of FIG. 5 could correspond to the same block. In this case, there could be three edge segments, corresponding to edge segments 100, 102, and 104. Edge segment 106 would not be considered an edge segment in this example, because blocks 108C and 108D would be the same block, in this example. As another example, blocks 108A and 108B could form one block, while blocks 108C and 108D could form another block. Nevertheless, the edge formed by these two blocks could be separated into edge segments 102 and 104, and the techniques of this disclosure could be used to analyze edge segments 102 and 104.

FIGS. 6A-6D are conceptual diagrams illustrating various examples of lines of pixels that may be analyzed in accordance with the techniques of this disclosure, when performing deblocking decisions. In these examples, i represents a number of pixels away from a top edge of the outer dashed lined box a horizontal line of pixels is, while j represents a number of pixels away from a left edge of the outer dashed lined box a vertical line of pixels is. In this manner, the top row immediately below the top edge of the outer dashed lined box represents an example of a reference row relative to which positions of pixels and lines of pixels may be defined. In this example, the line of pixels closest to the left (or top) edge of the outer dashed lined box is indexed at 0.

In the example of FIG. 6A, lines where i=2 and i=5 are used when performing deblocking decisions for vertical edge segments. Substituting j for i for horizontal edge segments, j=2 and j=5 are also used in FIG. 6A for the horizontal edge segments. In particular, FIG. 6A illustrates lines of pixels 120A-120D and edge segments 122A-122D. In this example, deblocker 90 (FIG. 4) may analyze line of pixels 120A to determine whether to deblock line segment 122A, and if so, whether to use a strong or weak filter, and if a weak filter, a width of the weak filter. Likewise, deblocker 90 may analyze line of pixels 120B to determine whether to deblock line segment 122B, and if so, whether to use a strong or weak filter, and if a weak filter, a width of the weak filter; line of pixels 120C to determine whether to deblock line segment 122C, and if so, whether to use a strong or weak filter, and if a weak filter, a width of the weak filter; and line of pixels 120D to determine whether to deblock line segment 122D, and if so, whether to use a strong or weak filter, and if a weak filter, a width of the weak filter.

Thus, in the example of FIG. 6A, lines of pixels 120A and 120B represent examples of lines of pixels for which j=2 and 5, respectively. That is, for line segment 120A, j=2, and for line of pixels 120B, j=5. Similarly, lines of pixels 120C and 120D represent examples of lines of pixels for which i=2 and 5, respectively. That is, for line segment 120C, i=2, and for line of pixels 120D, i=5. Alternatively, each of lines of pixels 120A-120D may be defined as having a distance of 2 pixels from a common point at which the four blocks forming edge segments 122A-122D meet.

In this manner, the example of FIG. 6A represents an example in which four blocks that share a common point define four edge segments, including a first edge segment extending above the common point, a second edge segment extending to the left of the common point, a third edge segment extending to the right of the common point, and a fourth edge segment extending below the common point. Furthermore, FIG. 6A represents an example in which, to deblock the four respective edge segments, a video coder may, for the first edge segment, analyze a first row of pixels perpendicular to the first edge segment that is the second row of pixels above the common point, for the second edge segment, analyze a first column of pixels perpendicular to the second edge segment that is the second column of pixels to the left of the common point, for the third edge segment, analyze a second column of pixels perpendicular to the third edge segment that is the second column of pixels to the right of the common point, and, for the fourth edge segment, analyze a second row of pixels perpendicular to the fourth edge segment that is the second row of pixels below the common point.

In the example of FIG. 6B, i=1 and i=6 are used when performing deblocking decisions for vertical edge segments, and j=1 and j=6 are used when performing deblocking decisions for horizontal edge segments. In particular, FIG. 6B illustrates lines of pixels 124A-124D and edge segments 126A-126D. In this example, deblocker 90 (FIG. 4) may analyze line of pixels 124A to determine whether to deblock line segment 126A, and if so, whether to use a strong or weak filter, and if a weak filter, a width of the weak filter. Likewise, deblocker 90 may analyze line of pixels 124B to determine whether to deblock line segment 126B, and if so, whether to use a strong or weak filter, and if a weak filter, a width of the weak filter; line of pixels 124C to determine whether to deblock line segment 126C, and if so, whether to use a strong or weak filter, and if a weak filter, a width of the weak filter; and line of pixels 124D to determine whether to deblock line segment 126D, and if so, whether to use a strong or weak filter, and if a weak filter, a width of the weak filter.

Thus, in the example of FIG. 6B, lines of pixels 124A and 124B represent examples of lines of pixels for which j=1 and 6, respectively. That is, for line segment 124A, j=1, and for line of pixels 124B, j=6. Similarly, lines of pixels 124C and 120D represent examples of lines of pixels for which i=1 and 6, respectively. That is, for line segment 124C, i=1, and for line of pixels 124D, i=6. Alternatively, each of lines of pixels 120A-120D may be defined as having a distance of 3 pixels from a common point at which the four blocks forming edge segments 126A-126D meet.

In the example of FIG. 6C, i=2 and i=6 are used when performing deblocking decisions for vertical edge segments, and j=2 and j=6 are used when performing deblocking decisions for horizontal edge segments. In particular, FIG. 6C illustrates lines of pixels 130A-130D and edge segments 132A-132D. In this example, deblocker 90 (FIG. 4) may analyze line of pixels 130A to determine whether to deblock line segment 132A, and if so, whether to use a strong or weak filter, and if a weak filter, a width of the weak filter. Likewise, deblocker 90 may analyze line of pixels 130B to determine whether to deblock line segment 132B, and if so, whether to use a strong or weak filter, and if a weak filter, a width of the weak filter; line of pixels 130C to determine whether to deblock line segment 132C, and if so, whether to use a strong or weak filter, and if a weak filter, a width of the weak filter; and line of pixels 130D to determine whether to deblock line segment 132D, and if so, whether to use a strong or weak filter, and if a weak filter, a width of the weak filter.

Thus, in the example of FIG. 6C, lines of pixels 130A and 130B represent examples of lines of pixels for which j=2 and 6, respectively. That is, for line segment 130A, j=2, and for line of pixels 130B, j=6. Similarly, lines of pixels 130C and 130D represent examples of lines of pixels for which i=2 and 6, respectively. That is, for line segment 130C, i=2, and for line of pixels 130D, i=6. Alternatively, lines of pixels 130A and 130C may be defined as having a distance of 2 pixels from a common point at which the four blocks forming edge segments 132A-132D meet, while lines of pixels 130B and 130D may be defined as having a distance of 3 pixels from the common point.

In the example of FIG. 6D, i=1 and i=5 are used when performing deblocking decisions for vertical edge segments, and j=1 and j=5 are used when performing deblocking decisions for horizontal edge segments. In particular, FIG. 6D illustrates lines of pixels 134A-134D and edge segments 136A-136D. In this example, deblocker 90 (FIG. 4) may analyze line of pixels 134A to determine whether to deblock line segment 136A, and if so, whether to use a strong or weak filter, and if a weak filter, a width of the weak filter. Likewise, deblocker 90 may analyze line of pixels 134B to determine whether to deblock line segment 136B, and if so, whether to use a strong or weak filter, and if a weak filter, a width of the weak filter; line of pixels 134C to determine whether to deblock line segment 136C, and if so, whether to use a strong or weak filter, and if a weak filter, a width of the weak filter; and line of pixels 134D to determine whether to deblock line segment 136D, and if so, whether to use a strong or weak filter, and if a weak filter, a width of the weak filter.

Thus, in the example of FIG. 6D, lines of pixels 134A and 134B represent examples of lines of pixels for which j=1 and 6, respectively. That is, for line segment 134A, j=1, and for line of pixels 134B, j=6. Similarly, lines of pixels 134C and 130D represent examples of lines of pixels for which i=1 and 6, respectively. That is, for line segment 134C, i=1, and for line of pixels 134D, i=6. Alternatively, lines of pixels 134A and 134C may be defined as having a distance of 3 pixels from a common point at which the four blocks forming edge segments 136A-136D meet, while lines of pixels 134B and 134D may be defined as having a distance of 2 pixels from the common point.

FIGS. 6A-6D illustrate various examples in which, for each of four edge segments formed by four blocks that share a common point, a respective at least one line of pixels comprises a respective line of pixels that is positioned i pixels away from the common point and includes three pixels on each side of the respective edge segment. Specifically, in the examples of FIGS. 6A-6D, for each of the four edge segments, i is either 2 or 3. As noted above, other positions are also possible. In any case, deblocker 90 may use these various lines of pixels when performing deblocking decisions, such as whether to deblock a corresponding edge segment, whether to use a strong or weak filter, and how many samples to modify in a weak filter (that is, a width of the weak filter).

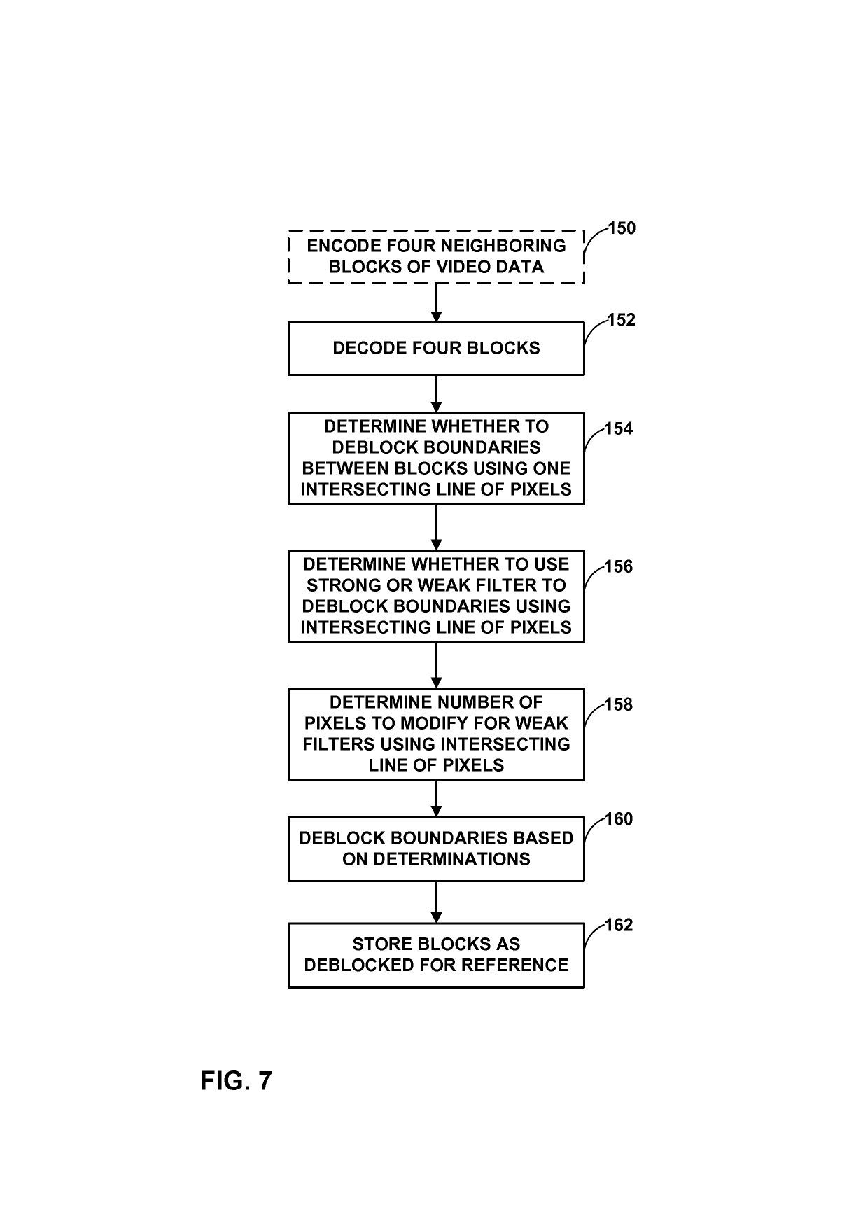

FIG. 7 is a flowchart illustrating an example method for deblocking boundaries between blocks in parallel in accordance with the techniques of this disclosure. The method of FIG. 7 may be performed by a video coder, such as video encoder 20 or video decoder 30. Certain steps in the method of FIG. 7 may be performed by a deblocker, such as deblocker 66 (FIG. 2), deblocker 84 (FIG. 3), or deblocker 90 (FIG. 4). For purposes of explanation, various components are described as performing the steps in the method of FIG. 7, although it should be understood that other components besides those described below may perform these or similar steps.

Initially, in the example of FIG. 7, a video encoder, such as video encoder 20, encodes four neighboring blocks of video data (150). When the method of FIG. 7 is performed by a video decoder, such as video decoder 30, the video decoder may instead receive and decode four encoded blocks of video data, rather than encoding the blocks. The four blocks may comprise four spatially neighboring, non-overlapping blocks that share one common point such that four edge segments are formed by the four blocks. For example, the four blocks may correspond to video blocks 108A-108D of FIG. 5, which share common point 110 and form edge segments 100-106. To encode the blocks, motion estimation unit 42 may perform motion searches to generate motion vectors for the blocks, and motion compensation unit 44 may generate predictive blocks using the motion vectors. Alternatively, intra-prediction unit 46 may generate predictive blocks using intra-prediction. Summer 50 may calculate residual blocks using the predictive blocks, and transform processing unit 52 and quantization unit 54 may transform and quantize the residual blocks, respectively.

Next, a video coder (e.g., video encoder 20 or video decoder 30) may decode the four blocks (152). For example, when performed by video encoder 20, inverse quantization unit 58 and inverse transform unit 60 may inverse quantize and inverse transform the residual blocks, and summer 62 may combine the reproduced residual blocks with predictive blocks to decode the blocks. When performed by video decoder 30, inverse quantization unit 76 and inverse transform unit 78 may inverse quantize and inverse transform residual blocks, and summer 80 may combine the reproduced residual blocks with predictive blocks from motion compensation unit 72 or intra-prediction unit 74 to decode the blocks.

Subsequently, a deblocker of the video coder, such as deblocker 90 (FIG. 4) may determine whether to deblock boundaries (that is, the edge segments) between the blocks using one intersecting line of pixels (154). As discussed above, deblocker 66 (FIG. 2) and/or deblocker 84 (FIG. 3) may conform substantially to deblocker 90. More particularly, deblocking determination unit 94 may analyze at least one line of pixels per edge segment (for four lines of pixels total), where the analyzed line of pixels is perpendicular to and intersects the respective edge segment. Deblocking determination unit 94 may analyze these lines of pixels for the edge segments substantially in parallel. The lines of pixels may correspond to, for example, lines 120A-120D (FIG. 6A), lines 124A-124D (FIG. 6B), lines 130A-130D (FIG. 6C), or lines 134A-134D (FIG. 6D). In other examples, other lines of pixels may be analyzed.

As discussed above, deblocking determination unit 94 may mathematically combine values of the pixels in the lines and compare these mathematically combined values to a value representative of boundary strength (e.g., β or β/2). For example, with respect to edge segment 122C of FIG. 6A, deblocking determination unit 94 may calculate and determine whether d₂<β/2, where:

dpᵢ=|p2ᵢ−2*p1ᵢ+p0ᵢ|,

dqᵢ=|q0ᵢ−2*q1ᵢ+q2ᵢ|,and

dᵢ=(dpᵢ+dqᵢ),using the notation explained with respect to FIG. 5.

As explained above, if this comparison evaluates to true, deblocking determination unit 94 may determine to deblock edge segment 122C, and otherwise, deblocking determination unit 94 may determine not to deblock edge segment 122C. In this manner, deblocking determination unit 94 may determine whether to deblock edge segment 122C using line of pixels 120C. Similarly, with respect to edge segment 122D of FIG. 6A, deblocking determination unit 94 may calculate and determine whether d₅<β/2, with similar results. Thus, deblocking determination unit 94 may determine whether to deblock edge segment 122D using line of pixels 120D. Likewise, with respect to edge segments 122A and 122B of FIG. 6A, deblocking determination unit 94 may calculate and determine similar values using lines of pixels 120A and 120B, respectively. In other examples, deblocking determination unit 94 may use other lines of pixels, such as discussed with respect to the examples of FIGS. 6B-6D.

Deblocker 90 may then determine whether to use a strong filter or a weak filter to deblock boundaries using the intersecting line of pixels (156) for those boundaries that deblocker 90 determined were to be deblocked. That is, for each of the edge segments that deblocking determination unit 94 determined was to be deblocked using at least one line of pixels, deblocking determination unit 94 may further determine whether to deblock the edge segment using a strong or a weak filter through a second analysis of the same intersecting line of pixels.

For example, again with respect to FIG. 6A, deblocking determination unit 94 may calculate swᵢ, where i=2 for line of pixels 120C (used to determine a strong or weak filter for edge segment 122C) and i=5 for line of pixels 120D (used to determine a strong or weak filter for edge segment 122D), where:

swᵢ=(2dᵢ<β/4)AND

[(|p3ᵢ−p0ᵢ|+|q0ᵢ−q3ᵢ|)<(β/8)]AND

[|p0ᵢ−q0ᵢ|<((5*t_{c}+1)/2)].

Deblocking determination unit 94 may then select a strong filter when swᵢ is true, and a weak filter otherwise. In this manner, deblocking determination unit 94 may determine whether to use a strong or a weak filter for edge segments determined to be deblocked using the same lines of pixels that was used to determine whether to deblock the edge segments. Similarly, deblocking determination unit 94 may use a similar formula for determining whether to apply strong or weak filters to edge segments 122A and 122B, based on lines of pixels 120A and 120B, respectively. In other examples, deblocking determination unit 94 may analyze other lines of pixels, such as the lines of pixels discussed with respect to FIGS. 6B-6D.

Moreover, deblocker 90 may determine a number of pixels to modify for the weak filters, again using the intersecting line of pixels (158). That is, for each of the edge segments that deblocking determination unit 94 determined was to be deblocked using a weak filter, deblocking determination unit 94 may further a width of the weak filter, e.g., whether to modify one or two pixels on either side of the respective boundary in each line of pixels that crosses the boundary.

For example, with respect to edge segment 122C, deblocking determination unit 94 may determine to modify two pixels in each of the rows intersecting edge segment 122C on the left side of edge segment 122C when dp₂<(3β/32), and to modify one pixel on the left side of edge segment 122C in each of the rows intersecting edge segment 122C otherwise. Similarly, deblocking determination unit 94 may determine to modify two pixels in each of the rows intersecting edge segment 122C on the right side of edge segment 122C when dq₂<(3β/32), and to modify one pixel on the right side of edge segment 122C in each of the rows intersecting edge segment 122C otherwise. Deblocking determination unit 94 may perform similar analyses, substantially in parallel, for edge segments 122B-122D. Of course, in other examples, deblocking determination unit 94 may analyze other lines of pixels, such as those described with respect to FIGS. 6B-6D.

After making the above determinations, deblocking filtering unit 96 may deblocking filter the edge segments for which deblocking filtering was determined, using either the strong or weak filter of the determined width (160). Furthermore, the deblocking filtering unit may output the deblocking filtered blocks, that is, the potentially modified pixel values of the four blocks. For example, deblocker 66 may output the deblocking filtered blocks when video encoder 20 performs the method, whereas deblocker 84 may output the deblocking filtered blocks when video decoder 30 performs the method. The video coder may then store the deblocking filtered blocks for reference when predicting subsequent blocks (162), e.g., using intra- or inter-prediction. For example, video encoder 20 may store the deblocking filtered blocks in reference picture memory 64, while video decoder 30 may store the deblocking filtered blocks in reference picture memory 82.

In this manner, the method of FIG. 7 represents an example of a method including decoding four blocks of video data, wherein the four blocks are non-overlapping and share one common point such that four edge segments are formed by the four blocks, for each of the four edge segments, determining whether to deblock the respective edge segment based on a first analysis of at least one respective line of pixels that is perpendicular to the respective edge segment and that intersects the respective edge segment, for each of the four edge segments that was determined to be deblocked, determining whether to apply a strong filter or a weak filter to the respective edge segment based on a second analysis of the at least one respective line of pixels for the respective edge segment, and deblocking one or more of the four edge segments based on the determinations.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
decoding a number of blocks of video data, wherein the blocks are non-overlapping and share one common point such that the same number of edge segments are formed by the blocks;
for each of the edge segments, determining whether to deblock the respective edge segment based on a first analysis of at least one respective line of pixels that is perpendicular to the respective edge segment and that intersects the respective edge segment;
for each of the edge segments that was determined to be deblocked, determining whether to apply a strong filter or a weak filter to the respective edge segment based on a second analysis of the at least one respective line of pixels for the respective edge segment; and
deblocking one or more of the edge segments based on the determinations.

2. The method of claim 1, wherein the number of blocks comprises one of two and three, wherein when the number of blocks comprises two, the number of edge segments comprises two, and wherein when the number of blocks comprises three, the number of edge segments comprises three.

3. The method of claim 1, wherein the first analysis comprises an analysis of the at least one respective line of pixels that is perpendicular to the respective edge and at least one line of pixels that is parallel to the respective edge.

4. The method of claim 1, wherein the number of blocks comprises four, and wherein the number of edge segments comprises four.

5. The method of claim 4, wherein the four edge segments comprise a first edge segment extending above the common point, a second edge segment extending to the left of the common point, a third edge segment extending to the right of the common point, and a fourth edge segment extending below the common point.

6. The method of claim 5, wherein determining whether to deblock the four respective edge segments comprises:
for the first edge segment, analyzing a first row of pixels perpendicular to the first edge segment that is the second row of pixels above the common point;
for the second edge segment, analyzing a first column of pixels perpendicular to the second edge segment that is the second column of pixels to the left of the common point;
for the third edge segment, analyzing a second column of pixels perpendicular to the third edge segment that is the second column of pixels to the right of the common point; and
for the fourth edge segment, analyzing a second row of pixels perpendicular to the fourth edge segment that is the second row of pixels below the common point.

7. The method of claim 4, wherein for each of the four edge segments, the respective at least one line of pixels comprises a respective line of pixels that is i pixels away from the common point and includes three pixels on each side of the respective edge segment.

8. The method of claim 7, wherein i is a value comprising one of 2 and 3.

9. The method of claim 4, wherein the four blocks comprise pixels defined by values (p or q) N (j), where p indicates that the respective pixel is on the left side of the common point, q indicates that the respective pixel is on the right side of the common point, N indicates a horizontal position of the respective pixel in terms of a number of columns to the left or right of the common point, and j indicates a vertical position of the respective pixel in terms of a number of rows from a reference row of the four blocks.

10. The method of claim 9, further comprising, for each of the four edge segments that was determined to be deblocked using a weak filter, determining whether to modify one or two samples of a deblocking filter to be applied to the respective edge segment based on a third analysis of the at least one line of pixels for the respective edge, wherein one of the respective lines of pixels includes pixels p2ᵢ, p1ᵢ, p0ᵢ, q0ᵢ, q1ᵢ, and q2ᵢ, wherein the third analysis comprises:
for pixels on the left side of the common point, determining to modify two samples when |p2ᵢ−2*p1ᵢ+p0ᵢ| is less than a threshold, and determining to modify one sample otherwise; and
for pixels on the right side of the common point, determining to modify two samples when |q0ᵢ−2*q1ᵢ+q2ᵢ| is less than the threshold, and determining to modify one sample otherwise.

11. The method of claim 10, wherein i is a value comprising one of 2 and 3.

12. The method of claim 10, wherein the threshold comprises 3*β/32, wherein β comprises a value representative of boundary strength for the edge segments.

13. The method of claim 10, wherein the threshold comprises 3*β/16, wherein β comprises a value representative of boundary strength for the edge segments.

14. The method of claim 9, wherein for each of the four edge segments, the respective at least one line of pixels comprises a respective line of pixels that is i pixels away from the common point and includes three pixels on each side of the respective edge segment, such that one of the respective lines of pixels includes pixels p2ᵢ, p1ᵢ, p0ᵢ, q0ᵢ, q1ᵢ, and q2ᵢ, and wherein the second analysis comprises:
determining a first binary value representative of whether 2*(|p2ᵢ−2*p1ᵢ+p0ᵢ|+|q0ᵢ−2*q1ᵢ+q2ᵢ|) is less than a threshold;
determining a second binary value representative of whether |p3ᵢ−p0ᵢ|+|q0i−q3i| is less than one half of the threshold;
determining a third binary value representative of whether |p0i−q0i|<((5*t_{c}+1)/2; and
determining whether to apply the strong filter or the weak filter based on a binary AND operation over the first binary value, the second binary value, and the third binary value.

15. The method of claim 14, wherein the threshold comprises β/4, wherein β comprises a value representative of boundary strength for the edge segments.

16. The method of claim 9, wherein the first analysis comprises determining to enable deblocking for at least one of the four edge segments when |p2ᵢ−2*p1ᵢ+p0ᵢ|+|p1ᵢ₋₁−2*p1ᵢ+p1ᵢ₊₁|+|q0ᵢ−2*q1ᵢ+q2ᵢ|+|q1ᵢ₋₁−2*q1ᵢ+q1ᵢ₊₁| is less than a threshold, and to disable deblocking for the at least one of the four edge segments otherwise.

17. The method of claim 16, wherein the threshold comprises β, wherein β comprises a value representative of boundary strength for the edge segments.

18. The method of claim 9, wherein the first analysis comprises determining to enable deblocking for at least one of the four edge segments when |p2ᵢ−4*p1ᵢ+p0ᵢ+p1ᵢ₋₁+p1ᵢ₊₁|+|q0ᵢ−4*q1ᵢ+q2ᵢ+q1ᵢ₋₁+q1ᵢ₊₁| is less than a threshold, and to disable deblocking for the at least one of the four edge segments otherwise.

19. The method of claim 18, wherein the threshold comprises β, wherein β comprises a value representative of boundary strength for the edge segments.

20. The method of claim 9, wherein the second analysis comprises:
determining a first binary value representative of whether |p2ᵢ−4*p1ᵢ+p0ᵢ+p1ᵢ₋₁+p1ᵢ₊₁|+|q0ᵢ−4*q1ᵢ+q2ᵢ+q1ᵢ₋₁+q1ᵢ₊₁| is less than β/4, wherein β comprises a value representative of boundary strength for the edge segments;
determining a second binary value representative of whether (|p3i−p0i|+|q0i−q3i|)<(β/8); and
determining a third binary value representative of whether (|p0i−q0i|)<((5*tc+1)/2; and
determining whether to apply the strong filter or the weak filter based on a binary AND operation over the first binary value, the second binary value, and the third binary value.

21. The method of claim 9, further comprising, for each of the four edge segments that was determined to be deblocked using a weak filter, determining whether to modify one or two samples of a deblocking filter to be applied to the respective edge segment based on a third analysis of the at least one line of pixels for the respective edge, wherein the third analysis comprises:
for pixels of the edge segment on the left of the common point, determining to modify two samples when |p2ᵢ−4*p1ᵢ+p0ᵢ+p1ᵢ₋₁+p1ᵢ₊₁| is less than 3β/16, wherein β comprises a value representative of boundary strength for the edge segments, and determining to modify one sample otherwise; and
for pixels of the edge segment on the right of the common point, determining to modify two pixels when |q0ᵢ−4*q1ᵢ+q2ᵢ+q1ᵢ₋₁+q1ᵢ₊₁| is less than 3β/16, wherein β comprises a value representative of boundary strength for the edge segments, and determining to modify one pixel otherwise.

22. The method of claim 1, further comprising encoding the blocks of video data prior to decoding the blocks of video data.

23. A device for coding video data, the device comprising a video coder configured to decode a number of blocks of video data, wherein the blocks are non-overlapping and share one common point such that the same number of edge segments are formed by the blocks, for each of the edge segments, determining whether to deblock the respective edge segment based on a first analysis of at least one respective line of pixels that is perpendicular to the respective edge segment and that intersects the respective edge segment, for each of the edge segments that was determined to be deblocked, determining whether to apply a strong filter or a weak filter to the respective edge segment based on a second analysis of the at least one respective line of pixels for the respective edge segment, and deblock one or more of the edge segments based on the determinations.

24. The device of claim 23, wherein the number of blocks comprises four.

25. The device of claim 24, wherein the four edge segments comprise a first edge segment extending above the common point, a second edge segment extending to the left of the common point, a third edge segment extending to the right of the common point, and a fourth edge segment extending below the common point.

26. The device of claim 25, wherein to determine whether to deblock the four respective edge segments, the video coder is configured to:
for the first edge segment, analyze a first row of pixels perpendicular to the first edge segment that is the second row of pixels above the common point;
for the second edge segment, analyze a first column of pixels perpendicular to the second edge segment that is the second column of pixels to the left of the common point;
for the third edge segment, analyze a second column of pixels perpendicular to the third edge segment that is the second column of pixels to the right of the common point; and
for the fourth edge segment, analyze a second row of pixels perpendicular to the fourth edge segment that is the second row of pixels below the common point.

27. The device of claim 23, wherein the four blocks comprise pixels defined by values (p or q) N (j), wherein p indicates that the respective pixel is on the left side of the common point, q indicates that the respective pixel is on the right side of the common point, N indicates a horizontal position of the respective pixel in terms of a number of columns to the left or right of the common point, and j indicates a vertical position of the respective pixel in terms of a number of rows from a reference row of the four blocks.

28. The device of claim 27, wherein the video coder is further configured to, for each of the four edge segments that was determined to be deblocked using a weak filter, determine whether to modify one or two samples of a deblocking filter to be applied to the respective edge segment based on a third analysis of the at least one line of pixels for the respective edge, wherein one of the respective lines of pixels includes pixels p2ᵢ, p1ᵢ, p0ᵢ, q0ᵢ, q1ᵢ, and q2ᵢ, wherein to perform the third analysis, the video coder is configured to:
for pixels on the left side of the common point, determine to modify two pixels when |p2ᵢ−2*p1ᵢ+p0ᵢ| is less than a threshold, and determine to modify one pixel otherwise; and
for pixels on the right side of the common point, determine to modify two pixels when |q0ᵢ−2*q1ᵢ+q2ᵢ| is less than the threshold, and determine to modify one pixel otherwise.

29. The device of claim 27, wherein for each of the four edge segments, the respective at least one line of pixels comprises a respective line of pixels that is i pixels away from the common point and includes three pixels on each side of the respective edge segment, such that one of the respective lines of pixels includes pixels p2ᵢ, p1ᵢ, p0ᵢ, q0ᵢ, q1ᵢ, and q2ᵢ, and wherein to perform the second analysis, the video coder is configured to:
determine a first binary value representative of whether 2*(|p2ᵢ−2*p1ᵢ+p0ᵢ|+|q0ᵢ−2*q1ᵢ+q2ᵢ|) is less than a threshold;
determine a second binary value representative of whether |p3ᵢ−p0ᵢ|+|q0i−q3i| is less than one half of the threshold;
determine a third binary value representative of whether |p0i−q0i|<((5*t_{c}+1)/2; and
determine whether to apply the strong filter or the weak filter based on a binary AND operation over the first binary value, the second binary value, and the third binary value.

30. The device of claim 27, wherein to perform the first analysis, the video coder is configured to determine to enable deblocking for at least one of the four edge segments when |p2ᵢ−2*p1ᵢ+p0ᵢ|+|p1ᵢ₋₁−2*p1ᵢ+p1ᵢ₊₁|+|q0ᵢ−2*q1ᵢ+q2ᵢ|+|q1ᵢ₋₁−2*q1ᵢ+q1ᵢ₊₁| is less than a threshold, and to disable deblocking for the at least one of the four edge segments otherwise.

31. The device of claim 27, wherein to perform the first analysis, the video coder is configured to determine to enable deblocking for at least one of the four edge segments when |p2ᵢ−4*p1ᵢ+p0ᵢ+p1ᵢ₋₁+p1ᵢ₊₁|+|q0ᵢ−4*q1ᵢ+q2ᵢ+q1ᵢ₋₁+q1ᵢ₊₁| is less than a threshold, and to disable deblocking for the at least one of the four edge segments otherwise.

32. The device of claim 24, wherein the video coder comprises a video decoder.

33. The device of claim 24, wherein the video coder comprises a video encoder that is further configured to encode the four blocks of video data prior to decoding the four blocks of video data.

34. A device for coding video data, the device comprising:
means for decoding a number of blocks of video data, wherein the blocks are non-overlapping and share one common point such that the same number of edge segments are formed by the blocks;
means for determining, for each of the edge segments, whether to deblock the respective edge segment based on a first analysis of at least one respective line of pixels that is perpendicular to the respective edge segment and that intersects the respective edge segment;
means for determining, for each of the edge segments that was determined to be deblocked, whether to apply a strong filter or a weak filter to the respective edge segment based on a second analysis of the at least one respective line of pixels for the respective edge segment; and
means for deblocking one or more of the edge segments based on the determinations.

35. The device of claim 34, wherein the number of blocks comprises four.

36. The device of claim 35, wherein the four edge segments comprise a first edge segment extending above the common point, a second edge segment extending to the left of the common point, a third edge segment extending to the right of the common point, and a fourth edge segment extending below the common point.

37. The device of claim 36, wherein the means for determining whether to deblock the four respective edge segments comprises:
means for analyzing, for the first edge segment, a first row of pixels perpendicular to the first edge segment that is the second row of pixels above the common point;
means for analyzing, for the second edge segment, a first column of pixels perpendicular to the second edge segment that is the second column of pixels to the left of the common point;
means for analyzing, for the third edge segment, a second column of pixels perpendicular to the third edge segment that is the second column of pixels to the right of the common point; and
means for analyzing, for the fourth edge segment, a second row of pixels perpendicular to the fourth edge segment that is the second row of pixels below the common point.

38. The device of claim 35, wherein the four blocks comprise pixels defined by values (p or q) N (j), where p indicates that the respective pixel is on the left side of the common point, q indicates that the respective pixel is on the right side of the common point, N indicates a horizontal position of the respective pixel in terms of a number of columns to the left or right of the common point, and j indicates a vertical position of the respective pixel in terms of a number of rows from a reference row of the four blocks.

39. The device of claim 38, further comprising means for determining, for each of the four edge segments that was determined to be deblocked using a weak filter, whether to modify one or two samples of a deblocking filter to be applied to the respective edge segment based on a third analysis of the at least one line of pixels for the respective edge, wherein one of the respective lines of pixels includes pixels p2ᵢ, p1ᵢ, p0ᵢ, q0ᵢ, q1ᵢ, and q2ᵢ, wherein to perform the third analysis, the device comprises:
means for determining, for pixels on the left side of the common point, to modify two pixels when |p2ᵢ−2*p1ᵢ+p0ᵢ| is less than a threshold, and means for determining to modify one pixel otherwise; and
means for determining, for pixels on the right side of the common point, to modify two pixels when |q0ᵢ−2*q1ᵢ+q2ᵢ| is less than the threshold, and means for determining to modify one pixel otherwise.

40. The device of claim 38, wherein for each of the four edge segments, the respective at least one line of pixels comprises a respective line of pixels that is i pixels away from the common point and includes three pixels on each side of the respective edge segment, such that one of the respective lines of pixels includes pixels p2ᵢ, p1ᵢ, p0ᵢ, q0ᵢ, q1ᵢ, and q2ᵢ, and wherein to perform the second analysis, the device comprises:
means for determining a first binary value representative of whether 2*(|p2ᵢ−2*p1ᵢ+p0ᵢ|+|q0ᵢ−2*q1ᵢ+q2ᵢ|) is less than a threshold;
means for determining a second binary value representative of whether |p3ᵢ−p0ᵢ|+|q0i−q3i| is less than one half of the threshold;
means for determining a third binary value representative of whether |p0i−q0i|<((5*t_{c}+1)/2; and
means for determining whether to apply the strong filter or the weak filter based on a binary AND operation over the first binary value, the second binary value, and the third binary value.

41. The device of claim 38, wherein to perform the first analysis, the device comprises means for determining to enable deblocking for at least one of the four edge segments when |p2ᵢ−2*p1ᵢ+p0ᵢ|+|p1ᵢ₋₁−2*p1ᵢ+p1ᵢ₊₁|+|q0ᵢ−2*q1ᵢ+q2ᵢ|+|q1ᵢ₋₁−2*q1ᵢ+q1ᵢ₊₁| is less than a threshold, and to disable deblocking for the at least one of the four edge segments otherwise.

42. The device of claim 38, wherein to perform the first analysis, the device comprises means for determining to enable deblocking for at least one of the four edge segments when |p2ᵢ−4*p1ᵢ+p0ᵢ+p1ᵢ₋₁+p1ᵢ₊₁|+|q0ᵢ−4*q1ᵢ+q2ᵢ+q1ᵢ₋₁+q1ᵢ₊₁| is less than a threshold, and to disable deblocking for the at least one of the four edge segments otherwise.

43. A computer-readable storage medium having stored thereon instructions that, when executed, cause a processor to:
decode a number of blocks of video data, wherein the blocks are non-overlapping and share one common point such that the same number of edge segments are formed by the blocks;
for each of the edge segments, determine whether to deblock the respective edge segment based on a first analysis of at least one respective line of pixels that is perpendicular to the respective edge segment and that intersects the respective edge segment;
for each of the edge segments that was determined to be deblocked, determine whether to apply a strong filter or a weak filter to the respective edge segment based on a second analysis of the at least one respective line of pixels for the respective edge segment; and
deblock one or more of the edge segments based on the determinations.

44. The computer-readable storage medium of claim 43, wherein the number of blocks comprises four.

45. The computer-readable storage medium of claim 44, wherein the four edge segments comprise a first edge segment extending above the common point, a second edge segment extending to the left of the common point, a third edge segment extending to the right of the common point, and a fourth edge segment extending below the common point.

46. The computer-readable storage medium of claim 45, wherein the instructions that cause the processor to determine whether to deblock the four respective edge segments comprise instructions that cause the processor to:
for the first edge segment, analyze a first row of pixels perpendicular to the first edge segment that is the second row of pixels above the common point;
for the second edge segment, analyze a first column of pixels perpendicular to the second edge segment that is the second column of pixels to the left of the common point;
for the third edge segment, analyze a second column of pixels perpendicular to the third edge segment that is the second column of pixels to the right of the common point; and
for the fourth edge segment, analyze a second row of pixels perpendicular to the fourth edge segment that is the second row of pixels below the common point.

47. The computer-readable storage medium of claim 44, wherein the four blocks comprise pixels defined by values (p or q) N (j), where p indicates that the respective pixel is on the left side of the common point, q indicates that the respective pixel is on the right side of the common point, N indicates a horizontal position of the respective pixel in terms of a number of columns to the left or right of the common point, and j indicates a vertical position of the respective pixel in terms of a number of rows from a reference row of the four blocks.

48. The computer-readable storage medium of claim 47, further comprising instructions that cause the processor to, for each of the four edge segments that was determined to be deblocked using a weak filter, determining whether to modify one or two samples of a deblocking filter to be applied to the respective edge segment based on a third analysis of the at least one line of pixels for the respective edge, wherein one of the respective lines of pixels includes pixels p2ᵢ, p1ᵢ, p0ᵢ, q0ᵢ, q1ᵢ, and q2ᵢ, wherein to perform the third analysis, the computer-readable storage medium comprises instructions that cause the processor to:
for pixels on the left side of the common point, determine to modify two pixels when |p2ᵢ−2*p1ᵢ+p0ᵢ| is less than a threshold, and determine to modify one pixel otherwise; and
for pixels on the right side of the common point, determine to modify two pixels when |q0ᵢ−2*q1ᵢ+q2ᵢ| is less than the threshold, and determine to modify one pixel otherwise.

49. The computer-readable storage medium of claim 47, wherein for each of the four edge segments, the respective at least one line of pixels comprises a respective line of pixels that is i pixels away from the common point and includes three pixels on each side of the respective edge segment, such that one of the respective lines of pixels includes pixels p2ᵢ, p1ᵢ, p0ᵢ, q0ᵢ, q1ᵢ, and q2ᵢ, and wherein to perform the second analysis, the computer-readable storage medium comprises instructions that cause the processor to:
determine a first binary value representative of whether 2*(|p2ᵢ−2*p1ᵢ+p0ᵢ|+|q0ᵢ−2*q1ᵢ+q2ᵢ|) is less than a threshold;
determine a second binary value representative of whether |p3ᵢ−p0ᵢ|+|q0i−q3i| is less than one half of the threshold;
determine a third binary value representative of whether |p0i−q0i|<((5*t_{c}+1)/2; and
determine whether to apply the strong filter or the weak filter based on a binary AND operation over the first binary value, the second binary value, and the third binary value.

50. The computer-readable storage medium of claim 47, wherein to perform the first analysis, the computer-readable storage medium comprises instructions that cause the processor to determine to enable deblocking for at least one of the four edge segments when |p2ᵢ−2*p1ᵢ+p0ᵢ|+|p1ᵢ₋₁−2*p1ᵢ+p1ᵢ₊₁|+|q0ᵢ−2*q1ᵢ+q2ᵢ|+|q1ᵢ₋₁−2*q1ᵢ+q1ᵢ₊₁| is less than a threshold, and to disable deblocking for the at least one of the four edge segments otherwise.

51. The computer-readable storage medium of claim 47, wherein to perform the first analysis, the computer-readable storage medium comprises instructions that cause the processor to determine to enable deblocking for at least one of the four edge segments when |p2ᵢ−4*p1ᵢ+p0ᵢ+p1ᵢ₋₁+p1ᵢ₊₁|+|q0ᵢ−4*q1ᵢ+q2ᵢ+q1ᵢ₋₁+q1ᵢ₊₁| is less than a threshold, and to disable deblocking for the at least one of the four edge segments otherwise.
